(19) United States
(12) Patent Application Publication
(10) Pub. No.: US 2015/0170119 A1
(43) Pub. Date: Jun. 18, 2015

(54) AUTOMATIC TRANSACTION DEVICE

(71) Applicant: Oki Electric Industry Co., Ltd., Tokyo (JP)

(72) Inventors: Akira Adachi, Tokyo (JP); Masaki Kobayashi, Tokyo (JP); Naohiro Yamada, Tokyo (JP)

(73) Assignee: Oki Electric Industry Co., Ltd., Tokyo (JP)

(21) Appl. No.: 14/407,824

(22) PCT Filed: Jun. 13, 2013
(86) PCT No.: PCT/JP2013/066402

§ 371 Date: Dec. 12, 2014

(30) Foreign Application Priority Data
Jul. 3, 2012 (JP) 2012-149207

(51) Int. Cl. G06Q 20/10

(52) U.S. Cl. CPC G06Q 20/102

(57) ABSTRACT

There is provided an automatic transaction device that carries out transactions of deposits and withdrawals of cash with a customer, having: a transfer opening at which transfer of bills is carried out; a bill processing section that carries out deposit processing of depositing bills of the transfer opening into the automatic transaction device interior, and dispensing processing of dispensing bills of the automatic transaction device interior to the transfer opening; and a recording section that, at a time of the deposit processing or the dispensing processing, records serial numbers of respective bills that are deposited or dispensed.

### TECHNICAL FIELD

The present invention relates to an automatic transaction device that carries out transactions of depositing and withdrawing of bills.

### BACKGROUND ART

Automatic transaction devices, that are exemplified by ATMs (Automated teller machines) of financial institutions, are set in a branch of a financial institution such as a bank or the like, or in a store such as a convenience store or the like. A customer can carry out transactions such as deposits, withdrawals, balance inquiries, and the like by carrying out various types of operations at a display screen that is displayed on the automatic transaction device.

By the way, a method in which bills that are loaded in an automatic transaction device are dispensed without being differentiated is employed in an automatic transaction device as disclosed in Japanese Patent Application Laid-Open (JP-A) No. 2003-162751 (Patent Document 1). Further, an automatic transaction device that recovers bills, that have been left behind, from a deposit/dispensing portion into a reject recovery box is disclosed in JP-A No. 2010-033416 (Patent Document 2).

### SUMMARY OF INVENTION

### Technical Problem

However, in the automatic transaction devices disclosed in above-described Patent Documents 1 and 2, various problems in operation can arise at the time of deposit and withdrawal transactions of bills.

For example, a take-in repository for taking-in bills that customers have left behind can store bills over the course of plural transactions. Therefore, if plural transactions are carried out by different customers, the bills in the take-in repository are bills of which customer cannot be specified. Further, there are cases in which, after a bill that has been dispensed is replaced with a counterfeit bill, the counterfeit bill is left behind intentionally. In such a case, the counterfeit bill is taken-into the take-in repository, but there is no way of demonstrating that the bill was replaced intentionally. Moreover, although there are cases in which counterfeit bills are dispensed from the automatic transaction device, the reason why such counterfeit bills became mixed-in cannot be specified. Note that, for example, counterfeit bills being loaded into the cassettes of the automatic transaction device is an example of this reason.

Thus, the present invention was made in consideration of the above-described problem, and an object of the present invention is to provide a novel and improved automatic transaction device that can appropriately handle problems that arise at the time of operation of the automatic transaction device.

### Solution to Problem

In order to overcome the above-described problem, in accordance with a certain aspect of the present invention, there is provided an automatic transaction device that carries out transactions of deposits and withdrawals of cash with a customer, comprising: a transfer opening at which transfer of bills is carried out; a bill processing section that carries out deposit processing of depositing bills of the transfer opening into the automatic transaction device interior, and dispensing processing of dispensing bills of the automatic transaction device interior to the transfer opening; and a recording section that, at a time of the deposit processing or the dispensing processing, records serial numbers of respective bills that are deposited or dispensed.

In accordance with this automatic transaction device, at the time of deposit processing or dispensing processing, the recording section records the serial numbers of the respective bills that are deposited or dispensed. Due thereto, bills that were deposited or dispensed can be specified easily, and therefore, it is easy to identify bills that were intentionally replaced or counterfeit bills that have become mixed-in or the like. Further, because it is easy to also know of the storage destination of a bill within the automatic transaction device, it is easy to return bills to a customer who held them in the first place.

Further, in the above-described automatic transaction device, it may be made such that there is further comprised: an authenticity discriminating section that discriminates authenticity of a bill; and a temporary storing portion that temporarily stores bills that have been discriminated as being genuine bills by the authenticity discriminating section, wherein, at a time of the deposit processing, the bill processing section conveys bills, that have been discriminated as being genuine bills, to the temporary storing portion, and conveys bills, that have been discriminated as not being genuine bills, to the transfer opening, and at the time of the deposit processing, the recording section records a serial number of each bill conveyed to the temporary storing portion, and a serial number of each bill conveyed to the transfer opening.

Further, in the above-described automatic transaction device, it may be made such that the recording section records, together with the serial number, a reason why a bill was discriminated as not being a genuine bill by the authenticity discriminating section.

Further, in the above-described automatic transaction device, it may be made such that there is further comprised: an authenticity discriminating section that discriminates authenticity of a bill; and a reject depository that, at a time of the dispensing processing, stores bills that have been discriminated as not being genuine bills by the authenticity discriminating section, wherein, at the time of the dispensing processing, the recording section records a serial number of each bill conveyed to the transfer opening, and a serial number of each bill conveyed to the reject depository.

Further, in the above-described automatic transaction device, it may be made such that the recording section records the serial numbers, and a number of bills that are deposited or dispensed.

Further, in the above-described automatic transaction device, it may be made such that, in a case in which bills, that were discriminated as not being genuine bills and were conveyed to the transfer opening, are not taken-out, the bill processing section conveys the bills of the transfer opening to a take-in repository, and the recording section records a serial number of each bill conveyed to the take-in repository.

Further, in the above-described automatic transaction device, it may be made such that, in a case in which bills, that were conveyed to the transfer opening, are not taken-out, the bill processing section conveys the bills of the transfer opening and the bills of the temporary storing portion to the take-in repository, and the recording section records a serial number of each bill conveyed to the take-in repository.

Further, in the above-described automatic transaction device, it may be made such that there is further comprised a plurality of cassettes that store bills per denomination, wherein the bill processing section further carries out storage processing of storing bills of the temporary storing portion in the cassettes per denomination, and at a time of the storage processing, the recording section records serial numbers of respective bills stored in the cassettes and cassettes that are storage destinations of the respective bills, in correspondence with one another.

Further, in the above-described automatic transaction device, it may be made such that there is further comprised a printing section that prints and outputs, onto a medium, the serial numbers of the respective bills stored in the cassettes.

Further, in the above-described automatic transaction device, it may be made such that, when the printing section prints, so as to be divided over plural media, the serial numbers of the respective bills stored in the cassettes, the printing section also prints a same transaction ID on the respective media.

Further, in the above-described automatic transaction device, it may be made such that the printing section prints, so as to be divided over a plurality of media, the serial numbers of the respective bills stored in the cassettes.

Further, in the above-described automatic transaction device, it may be made such that the printing section prints, onto a first medium, at least any one of a deposit amount, an account number and a balance, and, together with printing of the first medium, prints the serial numbers on a second medium.

Further, in the above-described automatic transaction device, it may be made such that the printing section also prints a same transaction ID on the respective media.

Further, in the above-described automatic transaction device, it may be made such that the printing section prints the serial numbers of the respective bills, and at least any one of a deposit amount, an account number and a balance, onto a same medium.

Further, in the above-described automatic transaction device, it may be made such that there is further comprised a transmission section that transmits the serial numbers of the respective bills stored in the cassettes to a server that sends an email, that includes the serial numbers of the bills, to a portable terminal.

### Advantageous Effects of Invention

As described above, in accordance with the present invention, problems arising at the time of operation of an automatic transaction device can be handled appropriately.

### BRIEF DESCRIPTION OF DRAWINGS

FIG. 1 is a drawing illustrating an example of the structure of an automatic transaction system 1 relating to a first embodiment.

FIG. 2 is a block diagram for explaining an example of the internal structure of an automatic transaction device 10 relating to the first embodiment.

FIG. 3 is a flowchart showing an example of operation of the automatic transaction device 10 relating to the first embodiment.

FIG. 4 is a drawing for explaining an example of recording of an electronic journaling section 140 in the first embodiment.

FIG. 5 is a flowchart showing an example of operation of the automatic transaction device 10 relating to a second embodiment.

FIG. 6 is a drawing for explaining an example of recording of the electronic journaling section 140 in the second embodiment.

FIG. 7 is a drawing illustrating an example of the structure of the automatic transaction system 1 relating to a third embodiment.

FIG. 8 is a flowchart showing an example of operation of the automatic transaction device 10 relating to the third embodiment.

FIG. 9 is a drawing for explaining an example of recording of the electronic journaling section 140 in the third embodiment.

FIG. 10 is a drawing showing an example of printing and outputting serial numbers of bills onto one receipt 310.

FIG. 11 is a drawing showing an example of printing and outputting serial numbers so as to be divided over two receipts 320, 321.

FIG. 12 is a drawing showing an example of printing and outputting serial numbers collectively on another receipt.

### DESCRIPTION OF EMBODIMENTS

Preferred embodiments of the present invention are described in detail hereinafter with reference to the appended drawings. Note that, in the present specification and drawings, repeat description of structural elements having substantially the same functional structures is omitted by denoting such elements by the same reference numerals.

### 1. First Embodiment

### 1-1. Example of Structure of Automatic Transaction System

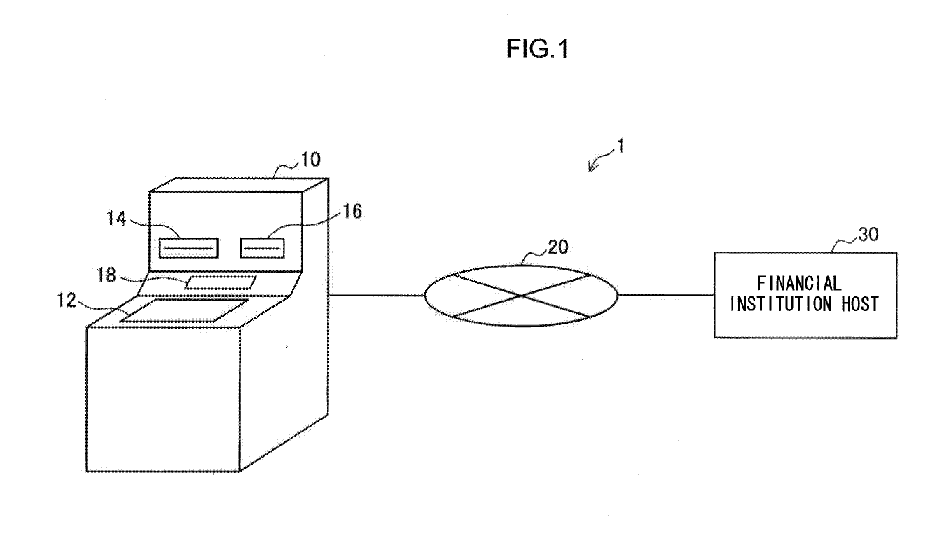

An example of the structure of an automatic transaction system relating to a first embodiment is described with reference to FIG. 1.

FIG. 1 is a drawing illustrating an example of the structure of an automatic transaction system 1 relating to the first embodiment. As shown in FIG. 1, the automatic transaction system 1 has an automatic transaction device 10, a private network 20, and a financial institution host 30.

The automatic transaction device 10 is a customer-operated terminal that executes transactions of cash, such as bills or the like, with a customer on the basis of operations by the customer of the financial institution. The automatic transaction device 10 can be set within various facilities such as, for example, an office of the financial institution, a convenience store, a station, or the like.

The automatic transaction device 10 has a customer operation/display portion 12, a passbook insertion opening 14, a card insertion opening 16, and a customer interface opening 18 that is an example of a transfer opening. The customer operation/display portion 12 functions as a display portion that displays screens that guide operations of the customer, and as a customer operation portion that detects operations of the customer. The function as a display portion is realized by, for example, a liquid crystal display device or the like. The function as a customer operation portion is realized by, for example, a touch panel.

The passbook insertion opening 14 carries out inserting and discharging of the passbook of the customer. The card insertion opening 16 carries out inserting and discharging of a cash card of the customer. The customer interface opening 18 is an opening at which transfer of cash to and from the customer is carried out, and functions as a deposit opening for bills by the customer, and a dispensing opening for bills to the customer.

The private network 20 is a network of the financial institution, and is structured by, for example, an IP-VPN (Internet Protocol-Virtual Private Network). The automatic transaction device 10 has a communication section (not illustrated), and can communicate with the financial institution host 30 via the private network 20.

The financial institution host 30 is a server that controls respective types of transactions by communicating with the automatic transaction device 10 via the private network 20. For example, the financial institution host 30 carries out verification of the customer who operates the automatic transaction device 10, and executes monetary transactions (account settlement transaction processings) such as deposits and transfers and the like that are instructed by a customer at the automatic transaction device 10. Further, the financial institution host 30 manages customer information (the ledger of the account) such as the account number, PIN, name, address, age, date of birth, phone number, occupation, family structure, income, account balance, and the like.

### 1-2. Example of Structure of Automatic Transaction Device

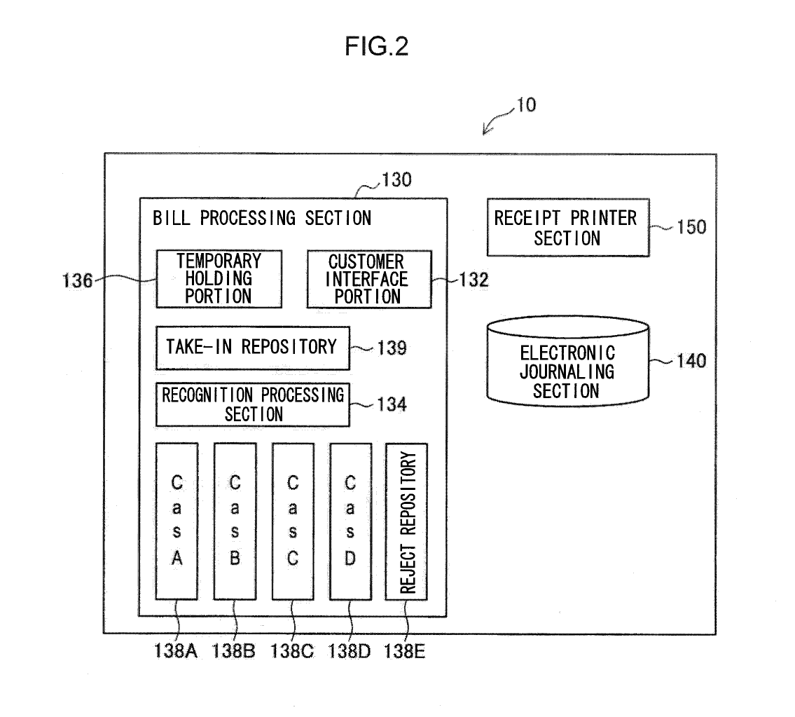

An example of the structure of the automatic transaction device 10 relating to the first embodiment is described with reference to FIG. 2.

FIG. 2 is a block diagram for explaining an example of the internal structure of the automatic transaction device 10 relating to the first embodiment. As shown in FIG. 2, the automatic transaction device 10 has a bill processing section 130, an electronic journaling section 140 that is an example of a recording section, and a receipt printer section 150 that is an example of a printing section. Note that FIG. 2 only illustrates some of the structural units of the automatic transaction device 10, and the automatic transaction device 10 also has units that, for example, carry out processings with respect to passbooks and cash cards and the like.

The bill processing section 130 is a section for carrying out processings relating to bills. For example, the bill processing section 130 carries out deposit processing of depositing bills of the customer interface opening 18 (see FIG. 1) into a temporary holding portion 136, storage processing of storing bills of the temporary holding portion 136 into cassettes 138A through 138D per denomination, and dispensing processing of dispensing bills of the cassettes 138A through 138D into the customer interface opening 18.

As shown in FIG. 2, the bill processing section 130 has a customer interface portion 132, a recognition processing section 134 that is an example of an authenticity discriminating section, the temporary holding portion 136 that is an example of a temporary storing portion, the plural cassettes 138A through 138D, a reject repository 138E, and a take-in repository 139. Further, the bill processing section 130 also has a conveying section (not illustrated) that conveys bills.

The customer interface portion 132 includes the customer interface opening 18 shown in FIG. 1, and functions as a deposit portion and a dispensing portion of bills. The recognition processing section 134 judges the authenticity of bills at the time of deposit processing or dispensing processing. Further, the recognition processing section 134 also carries out reading of the serial numbers that identify bills. The temporary holding portion 136 temporarily stores (accumulates) bills that have been inserted in from the customer interface portion 132 and that have been judged as being genuine bills by the recognition processing section 134. The cassettes 138A through 138A are provided per denomination for example, and store, per denomination, bills from the temporary holding portion 136. The reject depository 138E stores bills that have been judged as being reject bills at the time of dispensing. The take-in repository 139 stores reject bills at the time when a customer leaves behind reject bills of the customer interface portion 132.

The flow of processings that the bill processing section 130 carries out is described here. In a deposit processing, the bill processing section 130 first counts the bills that a customer or the like has inserted in the customer interface portion 132 (the customer interface opening 18), and, by the recognition processing section 134, carries out judgment of the authenticity of the bills. Then, the bill processing section 130 conveys to and accumulates in the temporary holding portion 136 the bills that have been judged to be genuine bills, and conveys to the customer interface portion 132 and returns to the customer the bills that have been judged to not be genuine bills.

After the deposit processing is completed, the bill processing section 130 carries out storage processing of conveying to and storing in the cassettes 138A through 138D, the bills that have been accumulated in the temporary holding portion 136. In the dispensing processing, the bill processing section 130 conveys bills, that correspond to the amount that the customer has requested, from the cassettes 138A through 138D via the recognition processing section 134 to the customer interface portion 132. At this time, the bills that are judged to be reject bills by the recognition processing section 134 are conveyed to the reject depository 138E. Note that bills that are conveyed in folded states, counterfeit bills that have become mixed-in in the cassettes 138A through 138D (e.g., counterfeit bills that a bank employee has mixed into the loading cassettes), and the like are judged to be reject bills. In the case of a counterfeit bill, the bill may be conveyed to a dedicated counterfeit bill take-in repository.

The electronic journaling section 140 electronically records the transaction history of the automatic transaction device 10 (e.g., the history of deposit transactions, withdrawal transactions, and the like), and the conveying history of bills, and the like. The electronic journaling section 140 records the history (a log or the like) when, for example, there is a write request from an application or the like. By recording the history in this way, trouble with customers, or the like, can be resolved by referring to the history at times when problems arise afterwards.

Here, at the time of a deposit processing or a dispensing processing, the electronic journaling section 140 records the serial number of each bill that is deposited or dispensed. Concretely, at the time of a deposit processing, the electronic journaling section 140 records the serial number of each bill that is conveyed to the temporary holding portion 136, and records the serial number of each bill that is conveyed to the customer interface portion 132. Due thereto, it is easy to specify each bill that has been subjected to the deposit processing and the destination to which the bill is conveyed. Further, at the time of a dispensing processing, the electronic journaling section 140 records the serial number of each bill that is conveyed to the customer interface portion 132, and the serial number of each bill that is conveyed to the reject depository 138E. Due thereto, it is easy to specify each bill that is subjected to the dispensing processing and the destination to which the bill is conveyed.

Further, in addition to the serial numbers, the electronic journaling section 140 also records the number of bills that are deposited or dispensed. Moreover, the electronic journaling section 140 also records the reason why a bill was discriminated as not being a genuine bill by the recognition processing section 134 (i.e., why a bill was discriminated as a reject bill). Due thereto, afterwards, the reason why a bill was rejected can be easily known.

The receipt printer section 150 is, for example, a printer, and has the function of printing a receipt that is a certificate certifying that the transaction has been carried out. For example, when there is a request from an application, the receipt printer section 150 prints a receipt that is an example of a medium.

### 1-3. Example of Operation of Automatic Transaction Device

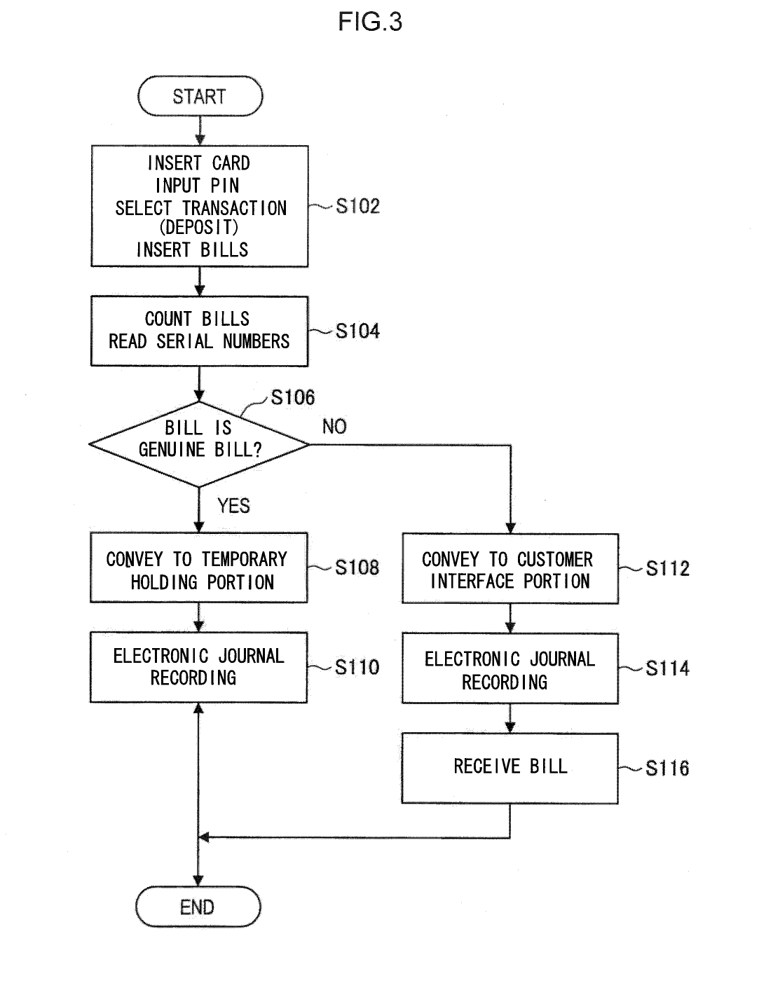

An example of the operation, at the time of a deposit transaction, of the automatic transaction device 10 that has the above-described structure is described with reference to FIG. 3.

FIG. 3 is a flowchart showing an example of the operation of the automatic transaction device 10 relating to the first embodiment. The flowchart of FIG. 3 is realized by, for example, the CPU of the control unit of the automatic transaction device 10 executing a program that is stored in the ROM. Note that the program that is executed may be stored on a recording medium such as a CD (Compact Disk), a DVD (Digital Versatile Disk), a memory card, or the like, or may be downloaded from a server or the like via the internet.

The flowchart of FIG. 3 is started from the time when a customer inserts a cash card into the card insertion opening 16 and inputs the PIN at the customer operation/display portion 12 and selects a deposit transaction (step S102). Then, it is assumed that the customer inserts the desired number of bills in the customer interface opening 18 (the customer interface portion 132). It is assumed here that four bills are inserted.

Next, after the bill processing section 130 starts counting of the four bills that have been inserted, reading of the serial numbers of the four bills is carried out by the recognition processing section 134 (step S104). Next, the bill processing section 130 carries out authenticity judgment of the four bills by the recognition processing section 134 (step S106).

Then, if it is judged in step S106 that a bill is a genuine bill (Yes), the bill processing section 130 conveys the bill that has been judged to be a genuine bill to the temporary holding portion 136 (step S108). Here, it is assumed that three of the four bills are judged to be genuine bills and are conveyed to the temporary holding portion 136. Next, the electronic journaling section 140 records the number of and the serial numbers of the bills that are accumulated in the temporary holding portion 136 (step S110).

On the other hand, if a bill is judged in step S106 to not be a genuine bill (No), the bill processing section 130 conveys the reject bill that was judged to not be a genuine bill (a counterfeit bill, a bill that is included in a predetermined list, a bill that cannot be judged, or the like) to the customer interface portion 132 (step S112). Note that the predetermined list is a list of bills to which attention must be paid, and is stored in advance in a storage section or the like. Here, it is assumed that the remaining one reject bill is conveyed to the customer interface portion 132. Next, the electronic journaling section 140 records the number of and the serial numbers of the reject bills that are conveyed (returned) to the customer interface portion 132 (step S114). Thereafter, the reject bill that is conveyed to the customer interface portion 132 is received by the customer (step S116).

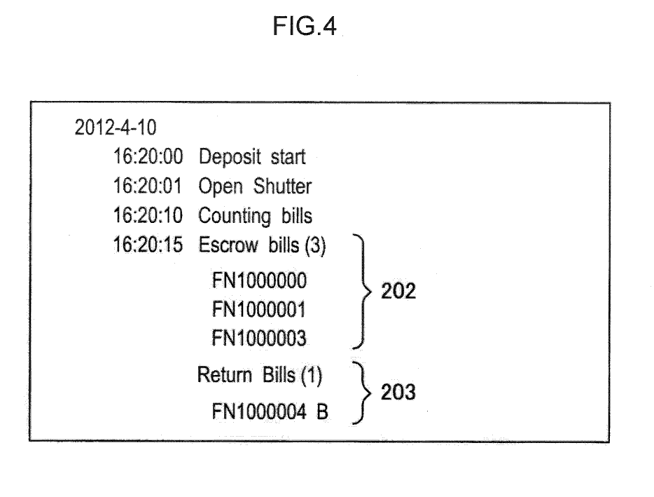

FIG. 4 is a drawing for explaining an example of recording of the electronic journaling section 140 in the first embodiment. As shown in FIG. 4, the electronic journaling section 140 records the history information of the deposit transaction. Further, in FIG. 4, it is recorded that three bills were conveyed to the temporary holding portion 136 (the reference numeral 202 portion), and that one reject bill was returned to the customer interface portion 132 (the reference numeral 203 portion). Note that numbers such as “FN1000000” and the like in FIG. 4 are examples of the serial numbers (serial numbers).

The electronic journaling section 140 may also record the reason why the reject bill that was returned to the customer interface portion 132 was rejected. For example, in FIG. 4, the serial number “FN1000004 B” relating to the reject bill expresses that the reject bill is a bill that is included in the predetermined list. Note that examples of other reasons why a bill has been rejected are that the bill could not be judged due to faulty operation or the like of the automatic transaction device 10, or that the bill was dirty, or the like.

### 1-4. Effectiveness of First Embodiment

In accordance with the above-described first embodiment, the results of transactions of all bills that customers insert for deposit transactions can be recorded by recording, in the electronic journaling section 140, the number of and the serial numbers of bills that are conveyed to the temporary holding portion 136 and the number of and the serial numbers of bills that are returned to the customer interface portion 132.

By recording the results of transactions in this way, claims by customers accompanying bill deposit transactions can be handled appropriately. For example, a claim by a customer that the amount of inserted bills is not reflected in the account can be addressed based on the record of the electronic journaling section 140 (as an example, the customer can be shown the contents of the record of the electronic journaling section 140 and told that reject bills were returned).

Further, by also recording in the electronic journaling section 140 the reasons why the reject bills that were returned to the customer interface portion 132 were rejected as described above, reasons for rejection can be easily discovered afterwards.

### 2. Second Embodiment

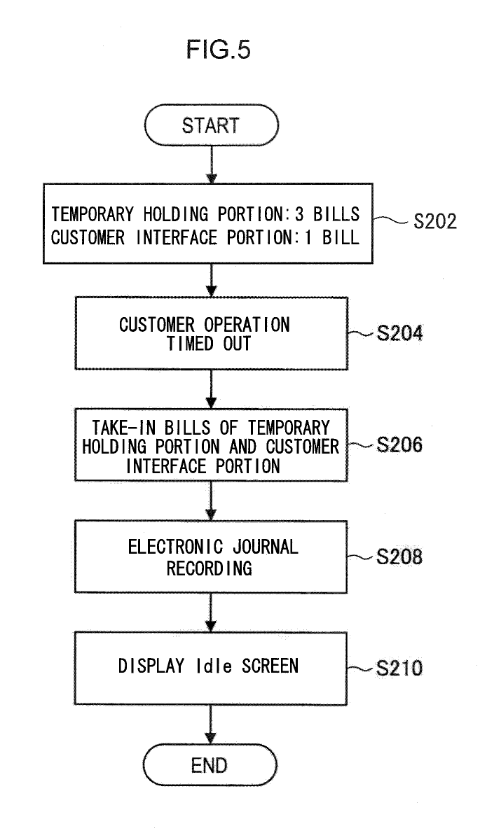

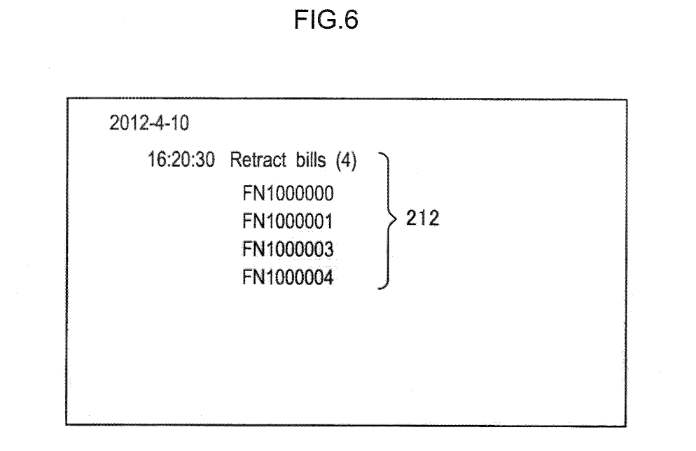

A second embodiment is described next with reference to FIG. 5 and FIG. 6.

An example of the structure of the automatic transaction device 10 relating to the second embodiment is similar to that of the first embodiment, and therefore, detailed description thereof is omitted. In the following explanation, an example of operation of the automatic transaction device 10 relating to the second embodiment is described. Concretely, description is given of a bill take-in processing in which, before a deposit transaction is completed, the bills of the customer interface portion 132 and the temporary holding portion 136 are taken into the take-in repository 139.

FIG. 5 is a flowchart showing an example of operation of the automatic transaction device 10 relating to the second embodiment. The flowchart of FIG. 5 is started from, in a deposit transaction, a state in which, of the plural bills that were inserted into the customer interface portion 132, bills that are genuine bills have been conveyed to the temporary holding portion 136, and reject bills have been returned to the customer interface portion 132 (step S202). Here, it is assumed that three bills that are genuine bills have been conveyed to the temporary holding portion 136, and one reject bill has been returned to the customer interface portion 132.

Next, for example, the bill processing section 130 senses that the customer has moved away from the automatic transaction device 10 in a state in which the deposit transaction has not been concluded (has not been reflected in the ledger) and a predetermined time has passed (timed out) (step S204). Here, it is assumed that the customer has left behind the bill that was returned to the customer interface portion 132.

Thus, the bill processing section 130 takes, into the take-in repository 139, the one bill that was returned to the customer interface portion 132 and the three bills that were accumulated in the temporary holding portion 136 (step S206). At this time, the electronic journaling section 140 records the number of and the serial numbers of the four bills that are taken into the take-in repository 139 (step S208). Next, the automatic transaction device 10 returns the display screen of the customer operation/display portion 12 to the idle screen and waits for operation of a customer thereafter (step S210).

FIG. 6 is a drawing for explaining an example of recording of the electronic journaling section 140 in the second embodiment. As shown in FIG. 6, the electronic journaling section 140 records information of the four bills that were taken into the take-in repository 139 (the reference numeral 212 portion).

In accordance with the second embodiment, bills that a customer has left behind (reject bills) can be specified by, in the bill take-in processing, recording in the electronic journaling section 140 the number of and the serial numbers of bills that were taken into the take-in repository 139 from the temporary holding portion 136 and the customer interface portion 132. Further, even if plural deposit transactions are carried out and plural bills are taken into the take-in repository 139, on the basis of the record of the electronic journaling section 140, bills that are to be returned to a customer can be specified easily, and the corresponding reject bills can be returned. Moreover, if the number of bills that a customer declares to have deposited and the actual number of bills differ, the record of the electronic journaling section 140 can also be used as proof.

### 3. Third Embodiment

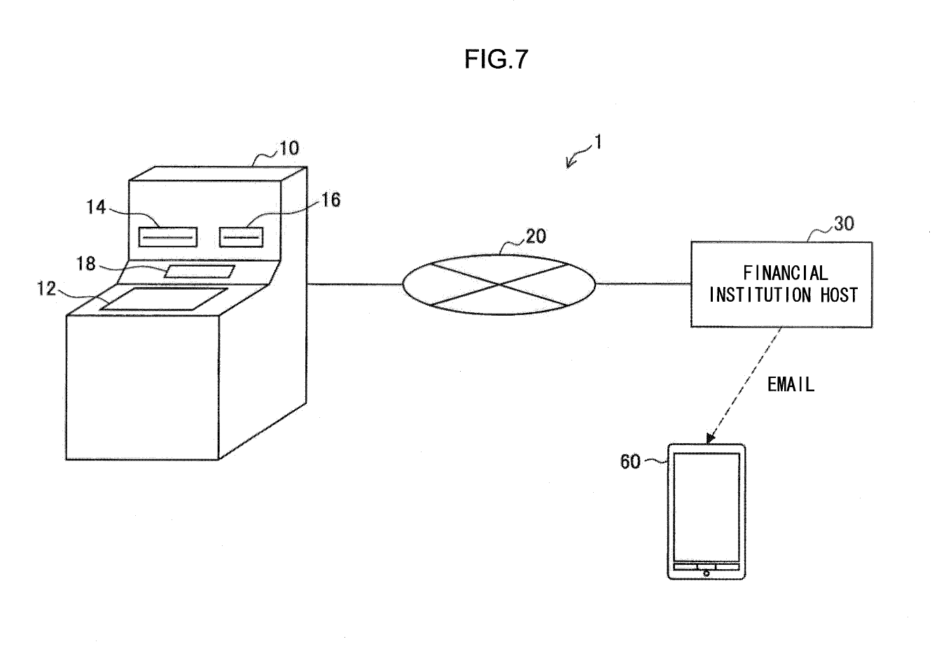

A third embodiment is described next with reference to FIG. 7 through FIG. 9.

FIG. 7 is a drawing showing an example of the structure of the automatic transaction system 1 relating to the third embodiment. In the automatic transaction system 1 shown in FIG. 7, differently than in the first embodiment, the financial institution host 30 and a portable terminal 60 carry out communication with one another. For example, the financial institution host 30 transmits electronic mail relating to a transaction of the automatic transaction device 10 to the portable terminal 60 such as a cell phone or a smart phone or the like. Further, the portable terminal 60 accesses the financial institution host 30, and acquires information relating to a transaction, and can display the information on the display portion.

Because the example of the structure of the automatic transaction device 10 relating to the third embodiment is similar to that of the first embodiment, detailed description thereof is omitted. Hereinafter, an example of operation of the automatic transaction device 10 relating to the third embodiment is described. Concretely, description is given of the processing of storing bills of the temporary holding portion 136 into the cassettes 138A through 138D.

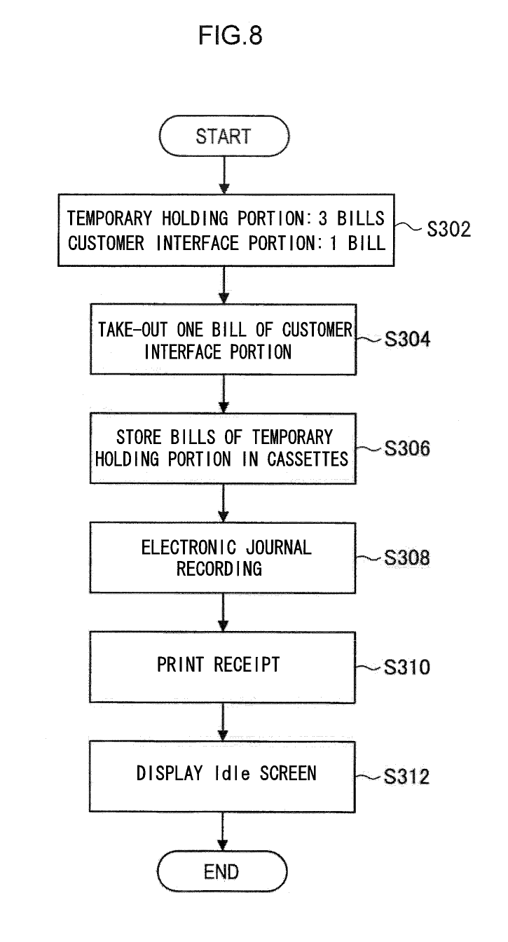

FIG. 8 is a flowchart showing an example of operation of the automatic transaction device 10 relating to the third embodiment. The flowchart of FIG. 8 is started from, in a deposit processing, a state in which, of plural bills that were inserted in the customer interface portion 132, bills that are genuine bills have been conveyed to the temporary holding portion 136, and reject bills have been returned to the customer interface portion 132 (step S302). Here, it is assumed that three bills that are genuine bills have been conveyed to the temporary holding portion 136, and one reject bill has been returned to the customer interface portion 132.

Next, after the customer takes-out the one reject bill that was returned to the customer interface portion 132, for example, the bill processing section 130 receives a transaction completing operation by the customer, and ends the deposit processing (step S304).

Next, the bill processing section 130 starts the storage processing that stores the bills, that have been accumulated in the temporary holding portion 136, in the cassettes 138A through 138D per denomination (step S306). The bills of the temporary holding portion 136 are conveyed to and stored in the cassettes 138A through 138D of the corresponding denominations. Further, the automatic transaction device 10 causes the results of the deposit processing to be reflected in the ledger.

Next, the electronic journaling section 140 records, in correspondence with one another, the serial numbers of the respective bills stored in the cassettes 138A through 138D and the cassettes 138A through 138D that are the storage destinations of the respective bills, at the time of the storage processing (step S308). By recording in this way, the storage destinations of the respective bills can be specified easily.

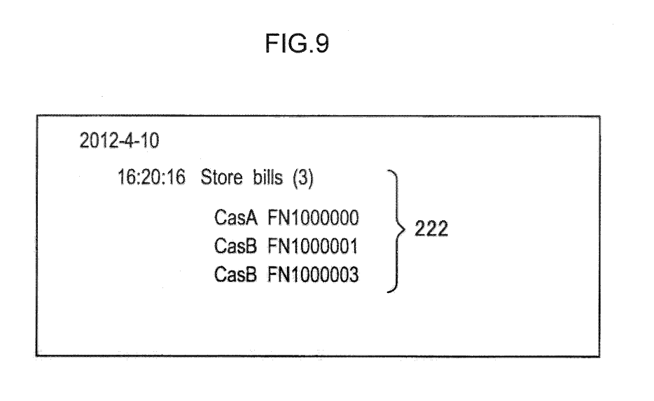

FIG. 9 is a drawing for explaining an example of recording of the electronic journaling section 140 in the third embodiment. As shown in FIG. 9, the electronic journaling section 140 records the bills and the cassettes, that are the storage destinations, in correspondence with one another (the reference numeral 222 portion).

Explanation continues by returning to the flowchart of FIG. 8. After recording by the electronic journaling section 140, the receipt printer section 150 outputs a receipt on which the serial numbers of the bills that were stored in the cassettes 138A through 138D are printed (step S310). If there is a large number of bills that were deposited, the receipt printer 150 prints the serial numbers of the respective bills over plural receipts. Note that, in a case in which the serial numbers are printed over plural receipts, it is preferable to print the same transaction ID on each receipt in order to show that they are for the same transaction.

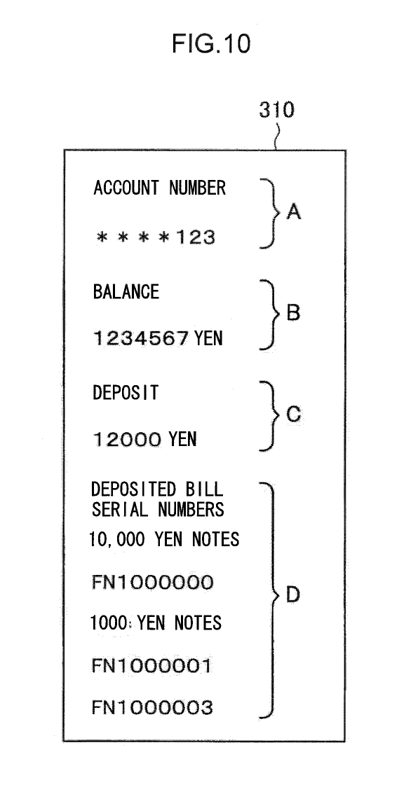

FIG. 10 is a drawing showing an example of printing and outputting serial numbers of bills on one receipt 310. As shown in FIG. 10, information relating to account number A, balance B, deposit C, and serial numbers D of the three deposited bills is printed on the receipt 310 that is outputted. The serial numbers D is further divided per denomination (into 10,000 yen notes and 1000 yen notes). Note that not all of the account number A, the balance B and the deposit C have to be printed, and it suffices to print at least any one thereof. By looking at the printed contents of the receipt 310, the customer can easily specify the serial number of a deposited bill.

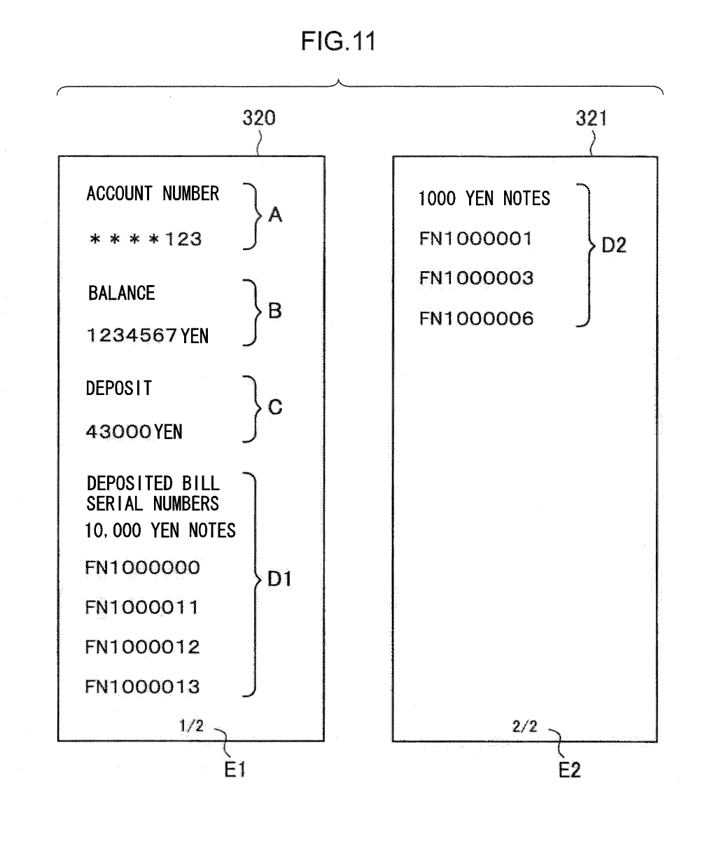

FIG. 11 is a drawing illustrating an example of printing and outputting by dividing the serial numbers over two receipts 320, 321. If it is judged that there is a large number of deposited bills (concretely, a larger number of bills than that which can be printed on a single receipt), as shown in FIG. 11, the automatic transaction device 10 prints the serial numbers of the bills over two (plural) receipts. Here, it is assumed that seven bills have been deposited. Information relating to the account number A, the balance B, the deposit C and serial numbers D1 of four bills out of the seven bills is printed on the first receipt 320, and information relating to serial numbers D2 of the remaining three bills is printed on the second receipt 321. Note that, as shown in FIG. 11, the serial numbers may be printed per denomination. Namely, only the serial numbers of the 10,000 yen notes are printed on the first receipt 320, and only the serial numbers of the 1000 yen notes are printed on the second receipt 321. Due thereto, the customer can easily specify the serial numbers of bills of different denominations. Further, in order to link the receipt 320 and the receipt 321, linking information (e.g., page numbers E1, E2 such as shown in FIG. 11) may be printed on each receipt.

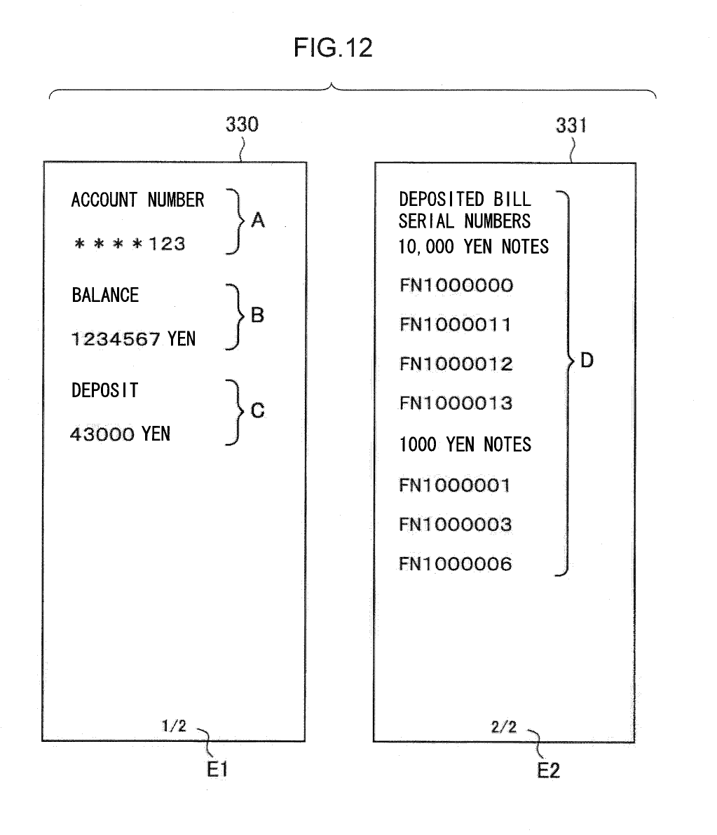

Although the serial numbers D are printed on the receipt together with the deposit C and the like in above-described FIG. 10 and FIG. 11, the present embodiment is not limited to this. For example, as shown in FIG. 12, among two receipts that are outputted, the deposit C and the like may be printed on one receipt, and only the serial numbers D may be printed on the other receipt.

FIG. 12 is a drawing illustrating an example of printing and outputting the serial numbers collectively on another receipt. As shown in FIG. 12, information relating to the account number A, the balance B, and the deposit C is printed on a first receipt 330, and information relating to the serial numbers of the bills is printed on a second receipt 331. By outputting the receipt 331 in which the serial numbers are printed collectively in this way, if there is a large number of bills that are deposited, it is easy for the customer to specify the serial numbers of all of the deposited bills merely by looking at the receipt 331.

When the receipt is printed, the automatic transaction device 10 returns the display screen of the customer operation/display portion 12 to the idle screen, and waits for operation of a customer thereafter (step S312).

Note that, in the above description, the serial numbers of the bills that have been stored in the cassettes 138A through 138D are printed on a receipt, but the present embodiment is not limited to this. The automatic transaction device 10 may, by a communication section, transmit the serial numbers of the respective bills that have been stored in the cassettes 138A through 138D to the financial institution host 30 that notifies the portable device 60 by electronic mail that includes the serial numbers of the bills and/or the transaction ID. In this case, the customer can, afterwards, access the financial institution host 30 from the portable terminal 60 via a network, and can, on the basis of the transaction ID, acquire information of the serial numbers of the bills and/or the cassettes that were the conveying destinations.

In accordance with the third embodiment, a customer can easily specify the number of and the serial numbers of deposited bills by referring to the serial numbers of the bills, that have been stored in the cassettes 138A through 138D, by using a receipt, electronic mail, or the internet on the basis of the transaction ID. Further, in cases of reference using electronic mail or the internet, the convenience of use for the customer improves because there is no need to receive a receipt.

### 4. CONCLUSION

As described above, at the time of a deposit processing or a dispensing processing, the electronic journaling section 140 of the automatic transaction device 10 records the serial numbers of the respective bills that are deposited or dispensed. Due thereto, bills that were deposited or dispensed can be specified easily, and therefore, it is easy to identify bills that were intentionally replaced or counterfeit bills that have become mixed-in or the like. Further, because it is easy to also know of the storage destination of a bill within the automatic transaction device, it is easy to return bills to a customer who held them in the first place.

Although preferred embodiments of the present invention have been described above in detail with reference to the appended drawings, the present invention is not limited to these examples. It is clear that persons having ordinary skill in the technical field to which the present invention belongs could conceive of various changed examples or modified examples within the scope of the technical concept put forth in the claims. It will be understood that such changed examples and modified examples as well of course fall within the technical scope of the present invention.

Further, the respective steps in the processings of the above-described automatic transaction device 10 do not necessarily have to be processed in time sequence in the order in which they were described in the flowcharts. For example, the respective steps in the processings of the automatic transaction device 10 may be processed in an order different than the orders described in the flowcharts, or may be processed in parallel.

Further, a computer program for causing the hardware, such as a CPU, a ROM, a RAM and the like that are incorporated within the automatic transaction device 10, to exhibit functions that are equivalent to those of the respective structures of the above-described automatic transaction device 10, also can be created.

The disclosure of Japanese Patent Application No. 2012-149207 is, in its entirety, incorporated by reference into the present specification.

All publications, patent applications, and technical standards mentioned in the present specification are incorporated by reference into the present specification to the same extent as if each individual publication, patent application or technical standard was specifically and individually indicated to be incorporated by reference.

1. An automatic transaction device that carries out transactions of deposits and withdrawals of cash with a customer, comprising:
a transfer opening at which transfer of bills is carried out;
a bill processing section that carries out deposit processing of depositing bills of the transfer opening into the automatic transaction device interior, and dispensing processing of dispensing bills of the automatic transaction device interior to the transfer opening; and
a recording section that, at a time of the deposit processing or the dispensing processing, records serial numbers of respective bills that are deposited or dispensed.

2. The automatic transaction device of claim 1, further comprising:
an authenticity discriminating section that discriminates authenticity of a bill; and
a temporary storing portion that temporarily stores bills that have been discriminated as being genuine bills by the authenticity discriminating section,
wherein, at a time of the deposit processing, the bill processing section conveys bills, that have been discriminated as being genuine bills, to the temporary storing portion, and conveys bills, that have been discriminated as not being genuine bills, to the transfer opening, and
at the time of the deposit processing, the recording section records a serial number of each bill conveyed to the temporary storing portion, and a serial number of each bill conveyed to the transfer opening.

3. The automatic transaction device of claim 2, wherein the recording section records, together with the serial number, a reason why a bill was discriminated as not being a genuine bill by the authenticity discriminating section.

4. The automatic transaction device of claim 1, further comprising:
an authenticity discriminating section that discriminates authenticity of a bill; and
a reject depository that, at a time of the dispensing processing, stores bills that have been discriminated as not being genuine bills by the authenticity discriminating section,
wherein, at the time of the dispensing processing, the recording section records a serial number of each bill conveyed to the transfer opening, and a serial number of each bill conveyed to the reject depository.

5. The automatic transaction device of claim 1, wherein the recording section records the serial numbers, and a number of bills that are deposited or dispensed.

6. The automatic transaction device of claim 2, wherein
in a case in which bills, that were discriminated as not being genuine bills and were conveyed to the transfer opening, are not taken-out, the bill processing section conveys the bills of the transfer opening to a take-in repository, and
the recording section records a serial number of each bill conveyed to the take-in repository.

7. The automatic transaction device of claim 6, wherein
in a case in which bills, that were conveyed to the transfer opening, are not taken-out, the bill processing section conveys the bills of the transfer opening and the bills of the temporary storing portion to the take-in repository, and
the recording section records a serial number of each bill conveyed to the take-in repository.

8. The automatic transaction device of claim 2, further comprising:
a plurality of cassettes that store bills per denomination, wherein
the bill processing section further carries out storage processing of storing bills of the temporary storing portion in the cassettes per denomination, and
at a time of the storage processing, the recording section records serial numbers of respective bills stored in the cassettes and cassettes that are storage destinations of the respective bills, in correspondence with one another.

9. The automatic transaction device of claim 8, further comprising a printing section that prints and outputs, onto a medium, the serial numbers of the respective bills stored in the cassettes.

10. The automatic transaction device of claim 9, wherein the printing section prints, so as to be divided over a plurality of media, the serial numbers of the respective bills stored in the cassettes.

11. The automatic transaction device of claim 9, wherein the printing section
prints, onto a first medium, at least any one of a deposit amount, an account number and a balance, and
together with printing of the first medium, prints the serial numbers on a second medium.

12. The automatic transaction device of claim 10, wherein the printing section also prints a same transaction ID on the respective media.

13. The automatic transaction device of claim 9, wherein the printing section prints the serial numbers of the respective bills, and at least any one of a deposit amount, an account number and a balance, onto a same medium.

14. The automatic transaction device of claim 8, further comprising a transmission section that transmits the serial numbers of the respective bills stored in the cassettes to a server that sends an email, that includes the serial numbers of the bills, to a portable terminal.
